(19) United States
(12) Patent Application Publication
(10) Pub. No.: US 2011/0008246 A1
(43) Pub. Date: Jan. 13, 2011

(54) SYSTEM AND METHOD FOR GENERATING NANOPARTICLES

(75) Inventors: Calvin Thomas Coffey, Watkins Glen, NY (US); Andrey V. Filippov, Beaver Dams, NY (US); Clinton Damon Osterhout, Beaver Dams, NY (US); Carlton Maurice Truesdale, Corning, NY (US)

Correspondence Address: CORNING INCORPORATED, SP-TI-3-1, CORNING, NY, 14831, US

(73) Assignee: CORNING INCORPORATED, Corning, NY (US)

(21) Appl. No.: 12/866,975

(22) PCT Filed: Feb. 23, 2009
(86) PCT No.: PCT/US2009/001135

§ 371 Date: Aug. 10, 2010

Related U.S. Application Data
(60) Provisional application No. 61/066,937, filed on Feb. 25, 2008.

(51) Int. Cl. C01B 13/22; B01J 19/00

(52) U.S. Cl. 423/613; 422/198; 977/773

(57) ABSTRACT

Systems and methods for generating nanomaterial are described wherein a reaction, for example, oxidation, for generating nanomaterial occurs in an open reaction zone which is external to the nanoparticle generator. The systems and methods minimize damage to the hot wall reactors evident in conventional systems and methods used to generate nanomaterial.

This application claims the benefit of priority to U.S. Patent Application No. 61/066,937 filed on Feb. 25, 2008.

### BACKGROUND

1. Field of the Invention

Embodiments of the invention relate to systems and methods for generating nanomaterial and more particularly to systems and methods for generating nanomaterial wherein a reaction for generating nanomaterial occurs in an open reaction zone which is external to the particle generator.

2. Technical Background

Over the years, there has been rapid progress in the areas of electronics, materials science, and nanoscale technologies resulting in, for example, smaller devices in electronics, advances in fiber manufacturing and new applications in the biotechnology field. The ability to generate and collect increasingly smaller, cleaner and more uniform particles is necessary in order to foster technological advances in areas which utilize small particulate matter. The development of new, efficient and adaptable ways of producing small particulate matter and subsequently collecting or depositing the small particulate matter onto a substrate becomes more and more advantageous.

The size of a particle often affects the physical and chemical properties of the particle or material comprising the particle. For example, optical, mechanical, biochemical and catalytic properties often change when a particle has cross-sectional dimensions smaller than 200 nanometers (nm). When particle sizes are reduced to smaller than 200 nm, these smaller particles of an element or a material often display properties that are quite different from those of larger particles of the same element or material. For example, a material that is catalytically inactive in the macroscale can behave as a very efficient catalyst when in the form of nanomaterial.

The aforementioned particle properties are valuable in many technology areas. For example, in optical fiber manufacturing, the generation of substantially pure silica and germania soot particles from impure precursors in a particular size range (about 5-300 nm) has been key in providing optical preforms capable of producing high purity optical fiber. Also, in the field of pharmaceuticals, the generation of particles having certain predetermined properties is advantageous in order to optimize, for example, in vivo delivery, bioavailability, stability of the pharmaceutical and physiological compatibility. The optical, mechanical, biochemical and catalytic properties of particles are closely related to the size of the particles.

Particle generators such as aerosol reactors have been developed for gas-phase nanoparticle synthesis. Examples of these aerosol reactors include flame reactors, tubular furnace reactors, plasma reactors, and reactors using gas-condensation methods, laser ablation methods, and spray pyrolysis methods.

Hot wall tubular furnace reactors have also proven adept for soot particle generation for silica preform production in optical fiber manufacturing, for example, those described in commonly owned US Patent Application Publications 2004/0187525 and 2004/0206127.

However, the above-mentioned reactors have some disadvantages. For example, flame reactors and flame spray pyrolysis reactors depend on a combustion process as a source of energy implying the presence of an oxidizing environment and presence of highly reactive intermediate combustion products. Combustion based processes restrict the scope of potential precursors and makes synthesis of many materials problematic. Gas-condensation methods are restricted to materials having relatively low vapor pressure, while plasma reactors often produce aerosols with high polydispersity caused by non-uniform conditions in the reaction zone.

Hot wall reactors typically use resistive heating elements or burners to supply energy to the walls of the reactor near the reaction zone. Although combustion is not needed to support chemical reactions in a hot wall reactor, and the process temperature can be precisely controlled, the inevitable contact between hot reacting species and the reactor walls causes deterioration of the reactor walls' mechanical and physical properties. Reactor wall degradation presents a limitation to the longevity of even the most advanced hot wall reactors.

Induction Soot Generators (ISGs) are examples of hot wall tubular furnace reactors using inductive heating elements to heat the reactor walls. ISGs have a number of advantages over other tubular soot generators. For example, combustion is not needed for supplying the energy to heat the reactor walls of the reaction zone in order to support the chemical reaction. Also, there is an increased ability to control the process temperature including the reaction temperature due to the increased control of the energy source as compared to generators using burner heating of the walls of the reaction zone.

However, ISGs do have some disadvantages. For example, the reactor walls of the reaction zone may become damaged due to exposure of the reactor walls to aggressive chemicals, such as chlorine (Cl) and oxygen (O) ions at high temperatures (above 1500° C.). These aggressive environmental conditions are damaging even for reactor walls made from platinum, rhodium, or a platinum\rhodium compound. As a result, the mechanical and induction properties of the reactor walls deteriorate over time. Also, this degradation of the reactor wall materials allows platinum and rhodium compounds to contaminate the synthesized particles. When degradation occurs, the reactor wall material must be replaced, which is both costly and time consuming.

It would be advantageous to have systems and methods for generating nanomaterial produced by gas-phase synthesis where degradation of the walls of the hot wall reactor is minimized. Further, it would be advantageous to mix and/or quench, and react precursor material external to where the precursor material is heated to the temperature needed to support a chemical reaction.

### SUMMARY

Systems and methods for generating nanomaterial, as described herein, address one or more of the above-mentioned disadvantages of conventional particle generators and methods of making nanomaterial and provide one or more of the following advantages: the nanomaterial forming reaction takes place in an open reaction zone external to where the precursor material is heated to the temperature needed to support a chemical reaction, which minimizes the contact between reaction byproducts and the walls of the hot wall reactor while retaining nanomaterial formation advantages of a hot wall reactor.

One embodiment of the invention is a method for generating nanomaterial. The method comprises providing a flow of a precursor material through an inlet of a hot wall reactor, heating the precursor material within the hot wall reactor in an inert atmosphere, and reacting the precursor material after exiting an outlet of the hot wall reactor to produce nanomaterial by exposing the precursor material to an oxidizing atmosphere to produce nanomaterial by oxidation of the precursor material.

Another embodiment of the invention is a system for generating nanomaterial. The system comprises a hot wall reactor for generating a flow of precursor material, and an enclosure defining the periphery of an inner passage and comprising an inlet and an outlet, wherein the inlet of the enclosure is adapted to receive a flow of precursor material from the hot wall reactor.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework for understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawing figures.

FIG. 1a is a schematic of a hot wall reactor according to one embodiment.

FIG. 1b is a schematic of a hot wall reactor according to one embodiment.

FIG. 1c is a schematic of a hot wall reactor according to one embodiment.

FIG. 2 is a schematic of a system according to one embodiment.

FIG. 3 is a schematic of a system according to one embodiment.

FIG. 4 is a schematic of features of a system according to one embodiment.

### DETAILED DESCRIPTION

In conventional methods of making particles using hot wall reactors, gaseous precursor material is supplied from one end of the hot wall reactor and is heated by thermal conductivity from the walls of the hot wall reactor to a temperature necessary for initiating and maintaining a chemical reaction. The chemical reaction(s) occur(s) inside the hot wall reactor and particles subsequently exit the opposite end of the hot wall reactor.

Typically, in the case when all precursor material is mixed initially, the chemical reaction starts in the location where the necessary reaction temperature is reached, yielding vapors of desired material. When conditions for vapor condensation are reached, the resulting material nucleates and condenses, forming aerosol particles. The particle sizes are typically in the range between several nanometers and some hundred nanometers, provided the conditions for particle agglomeration are there, such as high enough concentration of aerosol monomers.

Unfortunately, the presence of reaction byproducts heated to high temperature causes wall corrosion and deterioration even if the walls of the hot wall reactor are made from high temperature, chemically resistant materials. For example, platinum, rhodium, or a platinum\rhodium compounds used as wall materials in hot wall reactors have the disadvantage of pitting as Cl and O ions (exemplary reaction byproducts) at high temperatures (above 1500° C.) degrade the materials and deteriorate the wall material's heat generating capabilities.

Reference will now be made in detail to various embodiments of the invention, examples of which are illustrated in the accompanying drawings. Wherever possible, the same reference numbers will be used throughout the drawings to refer to the same or like parts.

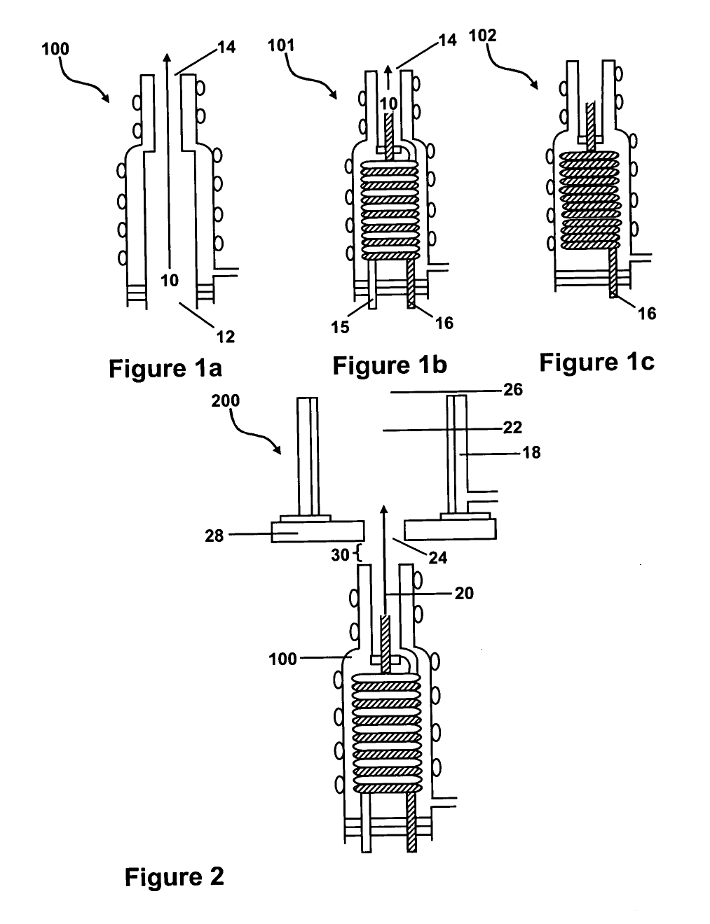

One embodiment of the invention is a method for generating nanomaterial. As shown in FIG. 1a, the method comprises providing a flow of a precursor material 10 through an inlet 12 of a hot wall reactor 100, heating the precursor material within the hot wall reactor in an inert atmosphere, and reacting the precursor material after exiting an outlet 14 of the hot wall reactor to produce nanomaterial by exposing the precursor material to an oxidizing atmosphere to produce nanomaterial by oxidation of the precursor material. In one embodiment, the inert atmosphere comprises an inert gas selected from argon, nitrogen, helium and combinations thereof.

In one embodiment, the hot wall reactor is selected from an induction particle generator, a resistive particle generator, a electromagnetic particle generator and combinations thereof. In one embodiment, the hot wall reactor is an induction particle generator.

In one embodiment, the precursor material can be heated at a temperature of from 1200 degrees Celsius to 1400 degrees Celsius, for example from 1280 degrees Celsius to 1300 degrees Celsius. The precursor material, in one embodiment, comprises a metal halide.

The method, according to one embodiment, further comprises cooling the reaction zone. The reaction zone can be cooled by conducting the reaction in a cooled enclosure. The enclosure can comprise quartz. The quartz can be in a stainless steel jacket. The enclosure can be cooled, for example, by flowing a coolant selected from water, antifreeze and a combination thereof through the jacket. The temperature of the coolant in a supply reservoir can be, for example, from below zero degrees Celsius to 25 degrees Celsius. In one embodiment, cooling comprises quenching the reaction zone. A quench refers to a rapid cooling. Quenching can be used to prevent low-temperature processes such as phase transformations from occurring by only providing a narrow window of time in which the reaction is both thermodynamically favorable and kinetically accessible. For instance, it can reduce crystallinity.

According to one embodiment, the method comprises reacting the precursor material exiting the outlet of the hot wall reactor by exposing the precursor material to an oxidizing atmosphere to produce nanomaterial by oxidation of the precursor material. In one embodiment, the oxidizing atmosphere comprises oxygen gas. In another embodiment, the oxidizing atmosphere comprises nitrous oxide.

In one embodiment, the nanomaterial comprises a metal oxide. The nanomaterial can comprise one metal oxide or can comprise more than one metal oxide. According to one embodiment, the nanomaterial is in the form of nanoparticles, a film, nanostructures, or combinations thereof. In one embodiment, the forms can be layered, for example, a layer of nanoparticles over a film over a layer of nanostructures (for instance, nanotubes, nanowires, nanostructured films having some morphology). The compositions and form of any of the layers or within an individual layer can be the same or can be different.

In another embodiment, the method further comprises collecting the nanomaterial. The collection of the nanomaterial, for example, comprises depositing the nanomaterial onto a substrate. The substrate, in one embodiment, is selected from a beaker, a flask, a slide, a conductive sheet, a non-conductive sheet, and combinations thereof. The nanomaterial can be bulk collected, for example, in powder form.

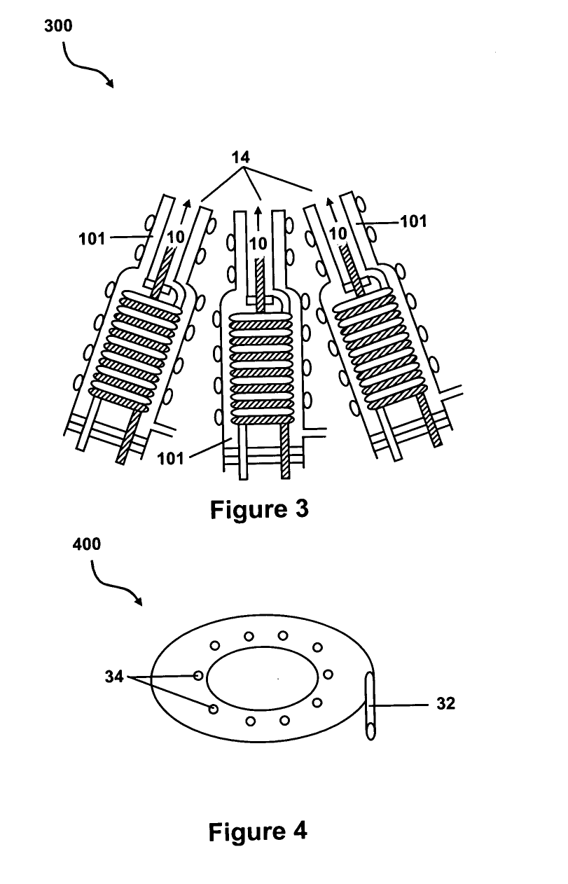

The method, in one embodiment, further comprises providing two or more flows of the precursor material. The two or more flows can be provided using two or more hot wall reactors as shown by features 300 of a system, according to one embodiment, in FIG. 3. When two or more hot wall reactors 101 are used, the precursor material 10 is heated in their respective hot wall reactors. The heated precursor material mixes, quenches, and reacts after exiting the outlets 14 of the hot wall reactors. According to some embodiments, the two or more flows can comprise the same precursor material or the two or more flows can comprise different precursor material.

In one embodiment, as shown in FIG. 1b, the two or more flows are provided within one hot wall reactor 101. In this embodiment, the precursor material in the hot wall reactor is heated to prescribed temperatures in separate delivery lines 15 and 16. The delivery lines can be made of a material, for example, selected from platinum, rhodium, or a platinum\rhodium compound. The delivery lines can be, for example, straight tubes or can be coiled into a helical configuration. The precursor material, in some embodiments, leaves their respective delivery lines, mixes, quenches, and reacts after exiting an outlet 14 of the hot wall reactor to produce nanomaterial.

In one embodiment, as shown in FIG. 1c, one hot wall reactor 102 can be used to produce a flow of precursor material. In this embodiment, the precursor material in the hot wall reactor is heated to prescribed temperatures in a single delivery line 16. The delivery line can be made of a material, for example, selected from platinum, rhodium, or a platinum\rhodium compound. The delivery line can be, for example, a straight tube or can be coiled into a helical configuration. In this embodiment, the flow can comprise a single precursor material or can comprise multiple species of precursor material.

Another embodiment of the invention is a system for generating particles. The system 200, as shown in FIG. 2, comprises a hot wall reactor 100 for generating a flow of precursor material 20, and an enclosure 18 defining the periphery of an inner passage 22 and comprising an inlet 24 and an outlet 26, wherein the inlet of the enclosure is adapted to receive a flow of precursor material from the hot wall reactor. The enclosure, according to one embodiment, is tubular. The enclosure can comprise quartz. The quartz can be in a stainless steel jacket.

In one embodiment, as shown in FIG. 2, the system 200 further comprises an insulator 28 positioned between the hot wall reactor and the inlet of the enclosure. The insulator, according to one embodiment, comprises a disk comprising a high temperature non-conductive material and having a diameter equal to or greater than the outer diameter of the reaction zone. The high temperature non-conductive material can be selected from quartz, fused silica, ceramic, mica and combinations thereof.

In one embodiment, the hot wall reactor is selected from an induction particle generator, a resistive particle generator, a electromagnetic particle generator and combinations thereof. In one embodiment, the hot wall reactor is an induction particle generator. Induction particle generators are examples of hot wall reactors using inductive heating elements to heat the reactor walls. Examples of such induction particle generators are described in patent application Ser. No. 11/502,286, filed on Aug. 10, 2006, and can be used to produce a flow of precursor material.

ISGs developed for synthesis of silica soot particles for use in optical fiber manufacturing are described in commonly owned US Patent Application Publication 2004/0206127 can be used to generate a flow of precursor material. The ISGs described in that reference have inductively heated reactor walls typically made of platinum, rhodium, or a platinum\rhodium compound. A description of one embodiment of an ISG in that reference also shows the use of Radio Frequency (RF) electromagnetic energy to heat certain portions of the reaction zone, and mentions the possible use of graphite as a suitable RF susceptor.

As shown in FIG. 2, in one embodiment, the insulator is spaced from the hot wall reactor defining a gap 30 there between. The spacing of the gap can be adjusted depending on the equipment used, the flow gas used, and/or other parameters used to produce the reaction generating the nanomaterial. In one embodiment, the gap is from one inch to 1/32 of an inch. For example, for the system used to produce an Inert-Quench process for making Titania, the gap was ⅛ of an inch.

According to one embodiment, the system further comprises a feed ring located in proximity to the gap. The feed ring comprises one or more feed holes for feeding a flow of gas in proximity to the inlet of the enclosure and is adapted to receive a flow of precursor material from the hot wall reactor. The feed ring can have a polygonal, circular, square, triangular, pentagonal, hexagonal shape, for example. The feed ring, according to one embodiment, comprises a high temperature non-conductive material. The high temperature non-conductive material can be selected from quartz, fused silica, ceramic, mica and combinations thereof.

In one embodiment, as shown in FIG. 4, the feed ring 400 is a toroid. The toroid is made from quartz tubing that is formed into the toroid. In this embodiment, the toroid comprises one or more ports 32, for example, a tangentially inserted quartz tube is used as an input port, and small, equally spaced holes 34 positioned in an upward angle around the inside diameter of the toroid are used as output ports.

The feed ring can be used to dispense ambient, heated or cooled gas or a mixture of gases. The feed ring can be used control the volume, the flow rate, and/or the pattern of the gases, for example, dispensing the gases in a circular and slightly upward pattern around the gap.

In some embodiments, the feed ring is mechanically attached to the bottom side of the insulator through attachment means known by one skilled in the art. According to one embodiment, the feed ring is not in physical contact with the hot wall reactor.

### Example 1

A flow of a precursor material was provided through an inlet of a hot wall reactor, in this example, an induction particle generator. The flow of precursor material was TiCl₄ with an inert gas, in this example, nitrogen. The precursor material was heated within the induction particle generator. The precursor material was reacted as it exited the outlet of the induction particle generator to produce titania nanomaterial by exposing the precursor material to an oxidizing atmosphere to produce nanomaterial by oxidation of the precursor material. The oxidizing environment was provided via a ⅛ of an inch gap between the insulator and the induction particle generator in a cooled enclosure. The cooled enclosure was a quartz cylinder having a water-cooled outer jacket made of stainless steel. Approximately 7.4 grams of titania nanomaterial was produced in approximately three hours. The nanomaterial was in the form of nanoparticles.

### Example 2

The method described in Example 1 was repeated with the following changes. The oxidizing environment was provided via a 1/16 of an inch gap between the tolerances of inside diameter of the insulator disk and the outer diameter of the outlet end of the induction particle generator in an enclosure without additional cooling. In this example, the enclosure was a quartz cylinder. Approximately 8.0 grams of titania nanomaterial was produced in approximately four hours.

### Example 3

The method described in Example 2 was repeated with the following changes. The oxidizing environment was provided via a ⅛ of an inch gap between the tolerances of inside diameter of the insulator disk and the outer diameter of the outlet end of the induction particle generator in an enclosure without additional cooling. Approximately 1.0 grams of titania nanomaterial was produced in approximately 75 minutes.

The systems and the methods for generating particles as described herein have one or more of the following advantages: the ability to produce a clean synthesis process, minimizing hydrocarbon combustion and preserving the interior of the hot wall reactor free of oxidizing species (as compared to flame reactors) and impurities from combustion and wall corrosion. Ability to separate the heating stage from the reaction zone, unlike in conventional reactors. Ability to produce particles using oxidation, and using physical reactions such as vaporization and condensation, as well as their combinations.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A method for generating nanomaterial, the method comprising:
providing a flow of a precursor material through an inlet of a hot wall reactor;
heating the precursor material within the hot wall reactor in an inert atmosphere; and
reacting the precursor material after exiting an outlet of the hot wall reactor to produce nanomaterial by exposing the precursor material to an oxidizing atmosphere to produce nanomaterial by oxidation of the precursor material.

2. The method according to claim 1, wherein the nanomaterial comprises a metal oxide.

3. The method according to claim 1, wherein the nanomaterial is in the form of nanoparticles, a film, nanostructures, or combinations thereof.

4. The method according to claim 1, wherein the precursor material comprises a metal halide.

5. The method according to claim 1, further comprising cooling the precursor material after exiting the outlet of the hot wall reactor.

6. The method according to claim 1, wherein the oxidizing atmosphere comprises oxygen gas.

7. The method according to claim 1, wherein the oxidizing atmosphere comprises nitrous oxide.

8. The method according to claim 1, wherein the inert atmosphere comprises an inert gas selected from argon, nitrogen, helium and combinations thereof.

9. The method according to claim 1, further comprising collecting the nanomaterial.

10. The method according to claim 9, wherein collecting the nanomaterial comprises depositing the nanomaterial onto a substrate.

11. The method according to claim 10, wherein the substrate is selected from a beaker, a flask, a slide, a conductive sheet, a non-conductive sheet, and combinations thereof.

12. The method according to claim 1, further comprising providing two or more flows of the precursor material.

13. The method according to claim 12, wherein the two or more flows are provided using two or more hot wall reactors.

14. The method according to claim 12, wherein the two or more flows are provided within one hot wall reactor.

15. The method according to claim 12, wherein the two or more flows comprise the same precursor material.

16. The method according to claim 12, wherein the two or more flows comprise different precursor materials.

17. A system comprising:
a hot wall reactor for generating a flow of precursor material; and
an enclosure defining the periphery of an inner passage and comprising an inlet and an outlet, wherein the inlet of the enclosure is adapted to receive a flow of precursor material from the hot wall reactor.

18. The system according to claim 17, further comprising an insulator positioned between the outlet of the hot wall reactor and the inlet of the enclosure.

19. The system according to claim 18, wherein the insulator is spaced from the hot wall reactor defining a gap there between.

20. The system according to claim 17, further comprising a feed ring located in proximity to the gap.

21. The system according to claim 17, wherein the hot wall reactor is selected from an induction particle generator, a resistive particle generator, electromagnetic particle generator and combinations thereof.

22. The system according to claim 17, wherein the enclosure is tubular.
